(19) United States
(12) Patent Application Publication
(10) Pub. No.: US 2007/0271031 A1
(43) Pub. Date: Nov. 22, 2007

(54) Method and apparatus for notifying departure time using schedule information

(75) Inventors: Suk-In Jung, Seoul (KR); Jong-Hyun Kim, Suwon-si (KR); Hyun-Suk Min, Suwon-si (KR); Hye-Jung Yang, Busan (KR); Jin-Won Kim, Seoul (KR); Kwang-Soo Kim, Seoul (KR); Sung Chul Yang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/725,179

(22) Filed: Mar. 16, 2007

(30) Foreign Application Priority Data
May 18, 2006 (KR) 2006-0044553

(51) Int. Cl. G01C 21/00

(52) U.S. Cl. 701/204

(57) ABSTRACT

A method and an apparatus for notifying a departure time using schedule information for providing accurate prediction of a departure time for user's convenience is disclosed. The method includes registering a schedule including route setup information such as an origin, a destination, and a desired arrival time; receiving real time traffic data; setting a route from the origin to the destination; calculating a required driving duration time for the route; determining a departure time by using the desired arrival time and the required driving duration time; updating the departure time by recalculating the required driving duration time for the route in advance of the departure time; and notifying the departure time at the departure time. The apparatus includes a schedule storage unit, a real time traffic data receiver, a control unit, and an alarm generator.

### PRIORITY

This application claims priority under 35 U.S.C. § 119 to an application entitled “Method And Apparatus For Notifying Departure Time Using Schedule Information” filed in the Korean Intellectual Property Office on May 18, 2006 and assigned Serial No. 2006-0044553, the contents of which are incorporated herein by reference.

### BACKGROUND OF THE INVENTION

1. Field of the Invention

The present invention relates generally to a method and an apparatus for notifying departure time, and in particular, to a method and an apparatus for generating an alarm to notify departure time by using schedule information including route information.

2. Description of the Prior Art

Driving duration ever for a single route varies due to increases in the number of automobiles on the roadway, traffic congestion and traffic accidents. For example, when departing for a destination, arrival time can vary according to day, time, and weather conditions, even if for the departure time remains the same.

People frequently do not timely arrive at their destination because of a lack of real time information concerning a driving route. Therefore, in order to arrive at the destination at a desired time, people tend to estimate departure time according to their respective experiences, or depart as early as possible with no particular plan.

However, if there are poor traffic conditions due to, for example, unexpected automobile accidents, people can arrive at their destination later than their desired arrival time. This can occur because of people's failure to consider aggravating traffic conditions such as accidents when estimating a departure time.

It is an inconvenience having to check, every time, the route and required driving duration to a destination, as well as to estimate departure time. Additionally, the estimation of the departure time according to personal experience is typically incorrect.

### SUMMARY OF THE INVENTION

The present invention has been made in view of the above-described problems, and an object of the present invention is to provide a method and an apparatus for notifying departure time with accurate prediction.

Another object of the present invention is to provide a method and an apparatus for notifying of departure time, thereby enabling prediction of the departure time corresponding to real time traffic data.

Another object of the present invention is to provide a method and an apparatus for notifying of departure time, thereby enabling users to arrive at a destination by using an optimum route without having to check the route and required duration.

In order to achieve the above objects of the present invention, a method for notifying of departure time according to the present invention includes registering a schedule including route setup information such as an origin, destination, and desired arrival time; receiving real time traffic data; setting a route from the origin to the destination; calculating required driving duration for the route; determining a departure time by using the desired arrival time and the required driving duration; updating the departure time by recalculating the required driving duration for the route in advance of the departure time; and notifying of the departure time at the departure time.

If the remaining duration time, which is the difference between the current times to the departure time, exceeds a predetermined waiting duration, then updating the departure time is preferably executed at predetermined intervals.

Preferably, updating the departure time includes setting a departure time update interval with half of the required driving duration time for the designated route, and updating at a time preceding the departure time with the departure time update interval.

Preferably, updating the departure time further includes resetting the departure time update interval with half of the previous departure time update interval at predetermined intervals.

If a reset departure time update interval is shorter than a predetermined base time interval, then preferably updating the departure time cancels the resetting of the departure time update interval.

If the current time has already passed the updated departure time, preferably, the method further includes resetting the route from the origin to the destination, and updating the departure time by using the reset route.

In determining the departure time, the time preceding the desired arrival time with the required driving duration is preferably determined as the departure time.

Notifying the departure time preferably includes displaying the determined departure time, and identifying a predetermined notification time of the departure time and outputting an alarm signal to notify the departure time at the notification time.

In order to achieve the above objects of the present invention, an apparatus for departure time notification according to the present invention includes a schedule storage unit for storing a schedule having route setup information such as an origin, destination, and desired arrival time; a real time traffic data receiver for receiving real time traffic data; a control unit for determining, by using route setup information stored in the schedule storage unit, departure time for arrival at the destination at the desired arrival time, and in advance of the departure time, updating the departure time corresponding to the real time traffic data; and an alarm generator for outputting an alarm signal to notify of the departure time at notification time of the departure time.

Preferably, the control unit identifies the origin and the destination for determining the departure time of the schedule, sets a route from the origin to the destination, calculates the required driving duration time for the route, and determines the departure time by using the desired arrival time and required driving duration of the corresponding schedule. Prior to the departure time, the control unit, preferably, updates the departure time by recalculating the required driving duration time for the route. If the remaining duration time from the current time to the departure time exceeds a predetermined waiting duration time, the control unit preferably updates the departure time. The control unit preferably updates the departure time at predetermined intervals.

Preferably, the control unit sets half of the required driving duration time for the route as a departure time update interval, and updates the departure time at the time preceding the departure time by the departure time update interval. The control unit preferably replaces the departure time interval with half of the previous departure time update interval at predetermined intervals. The control unit preferably cancels the resetting, if the reset departure time update interval is shorter than a predetermined base time interval.

If the current time has already passed the departure time, preferably, the control unit resets the route from the origin to the destination, and updates the departure time by using the reset route. The control unit preferably determines the time preceding the desired arrival time by the required driving duration time as the departure time.

The control unit preferably controls the alarm generator to output the determined departure time at the point of determining the departure time.

### BRIEF DESCRIPTION OF THE DRAWINGS

The above and other objects, features and advantages of the present invention will become more apparent from the following detailed description in conjunction with the accompanying drawings, in which:

FIG. 1 is a schematic block diagram showing an apparatus for notifying departure time according to the present invention;

FIG. 2 is a flow chart showing a method of notifying departure time according to the present invention;

FIG. 3 is a flow chart showing a method of notifying departure time according to another embodiment of the present invention; and

FIGS. 4A to 4D are views showing examples of schedule reference screens of an apparatus for notifying departure time according to the present invention.

### DETAILED DESCRIPTION OF THE PREFERRED EMBODIMENTS

Hereinafter, preferred embodiments of the present invention will described in detail with reference to the accompanying drawings. The same reference numbers are used for the same or like components in the drawings. Additionally, detailed explanations for well-known functions and compositions may be omitted to avoid obscuring the subject matter of the present invention.

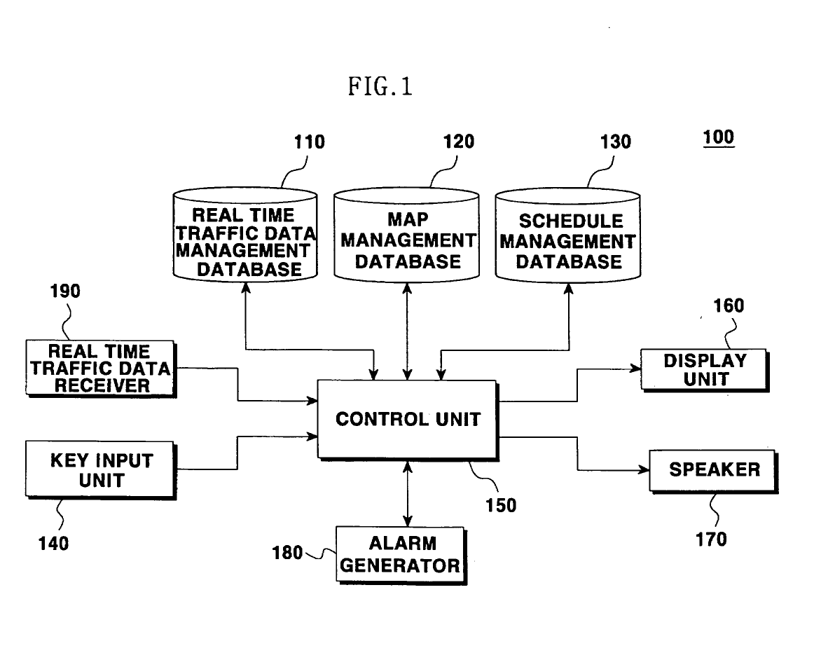

FIG. 1 is a schematic block diagram showing an apparatus for notifying departure time according to the present invention.

Referring to FIG. 1, the apparatus 100 for notifying departure time according to of the present invention includes a real time traffic data management database 110, a map management database 120, a schedule management database 130, a key input unit 140, a control unit 150, a display unit 160, a speaker 170, an alarm generator 180, and a real time traffic data receiver 190.

The real time traffic data management database 110 stores and manages real time traffic data including distances of sections, driving speed, and a required driving duration time, which are received by the real time traffic data receiver 190.

The map management database 120 stores and manages electronic maps including electronic map data such as a driving distance, an average driving speed, and a driving direction of each section of a road indicated on the map.

The schedule management database 130 stores and manages a schedule including route setup information such as an origin, a destination, and a desired arrival time.

The key input unit 140 provides a user interface for inputting a user's operation signal for controlling the operation of the apparatus 100 for notifying departure time. The key input unit 140 inputs and transmits a user's operation signal to the control unit 150 for registering a schedule including route setup information such as an origin, a destination, and a desired arrival time.

The control unit 150 controls the operation of the apparatus 100 for notifying departure time corresponding to a signal input from the key input unit 140, or by a pre-stored operation program. Preferably, the control unit 150, by using the route setup information stored in the schedule management database 130, determines departure time for arrival at the corresponding destination at the desired arrival time, and updates the departure time by using real time traffic data in advance of the departure time. Additionally, the control unit 150 identifies an origin and destination corresponding to a schedule, sets a route from the origin to the destination, calculates required driving duration time for the route, and determines departure time by using the desired arrival time and the required driving duration time of the corresponding schedule. Preceding the departure time, the control unit 150 updates the departure time by recalculating the required driving duration time for the route.

For this, the control unit 150 preferably receives the real time traffic data by controlling the real time traffic data receiver 190, and recalculates the required driving duration time of the route by using the real time traffic data.

If the remaining duration time from the current time to the departure time exceeds a predetermined waiting duration, time the control unit 150 preferably updates the departure time. The control unit 150 preferably updates the departure time at predetermined intervals.

Preferably, the control unit 150 sets half of the required driving duration time for the route as a departure time update interval, and updates the departure time at the time preceding the departure time by the departure time update interval. The control unit 150 preferably resets the departure time interval with half of the previous departure time update interval at predetermined intervals.

For example, when an estimated departure time is 14:00 and required driving duration time for the route is 2 hours, the departure time update interval is reset with 1 hour as a half of the required driving duration time and the departure time is updated to 13:00, which is 1 hour before 14:00. Subsequently, the departure time update interval is set with 30 minutes as half of the previous departure time update interval (1 hour) and the departure time is updated at 13:30, which is 30 minutes before 14:00. Further, the departure time update interval is reset with 15 minutes as half of the previous departure time update interval (30 minutes) and the departure time is updated at 13:45, which is 15 minutes before 14:00. The control unit 150 repeats the above steps until reaching the notification time of the departure time.

If the reset departure time update interval is shorter than a predetermined base time interval, the control unit 150 preferably cancels the resetting. For example, when the reset departure time update interval is 15 minutes and the predetermined base time interval is 10 minutes, the control unit 150 resets the departure time update interval with 7.5 minutes as half of the previous departure time update interval (15 minutes), but cancels the resetting because the reset departure update interval is shorter than the base time interval (10 minutes). That is, the previous value of the departure time update interval is maintained rather than resetting the departure time update interval. For example, the departure time updated at 13:45 is maintained and the value of the departure time update interval is replaced by the value of the base time interval (10 minutes).

If the current time has already passed the departure time (i.e., if the current time has already passed departure time for a predetermined route calculated by using real time traffic data), the control unit preferably resets the route from the origin to the destination, and updates the departure time by using the reset route. For example, after determining the departure time, if the required driving duration time has rapidly increased due to a particular condition such as accidents, the current time can have already passed the departure, which is time calculated based on the increased required driving duration time. In this case, the control unit 150 preferably resets the route by using the current traffic data, and updates the departure time by using the reset route. Accordingly, the control unit 150 preferably receives the real time traffic data by controlling the real time traffic data receiver 190, sets a new route by using the real time traffic data, and recalculates the required driving duration time for the route.

For example, where the desired arrival time is 17:00, required driving duration time is 30 minutes, and estimated departure time is 16:30, if the required driving duration time for the route has increased to 1 hour due to an accident in the route and the control unit 150 updates the departure time at 16:10, recalculated departure time will be 16:00, which means that the current time (16:10) has already passed the recalculated departure time. Accordingly, the control unit 150 must reset the route from the origin to the destination and update the departure time by using the reset route.

The control unit 150 preferably controls the display unit 160 or the speaker 170 to output the determined departure time at the point of determining the departure time. This is to enable a user to identify the determined departure time at the point of determining the departure time.

The display unit 160 and the speaker 170 output information generated in relation to the operation of the apparatus 100 for notifying departure time. The display unit 160 and the speaker 170 output an alarm signal generated by the alarm generator 180, and output video data and audio data respectively.

The alarm generator 180 receives the departure time determined by the control unit 150, and outputs an alarm signal to notify the departure time. The alarm generator 180 preferably identifies a predetermined notification time of the departure time, and outputs the alarm signal to notify the departure time at the notification time of the departure time.

The real time traffic data receiver 190 receives real time traffic data under the control of the control unit 150. The real time traffic data receiver 190 preferably receives Digital Media Broadcasting (DMB) data including Transport Protocol Experts Group (TPEG) data from a DMB network, and detects the real time traffic data from the TPEG data. The detected TPEG data are preferably stored in the real time traffic data management database 110 through the control unit 150.

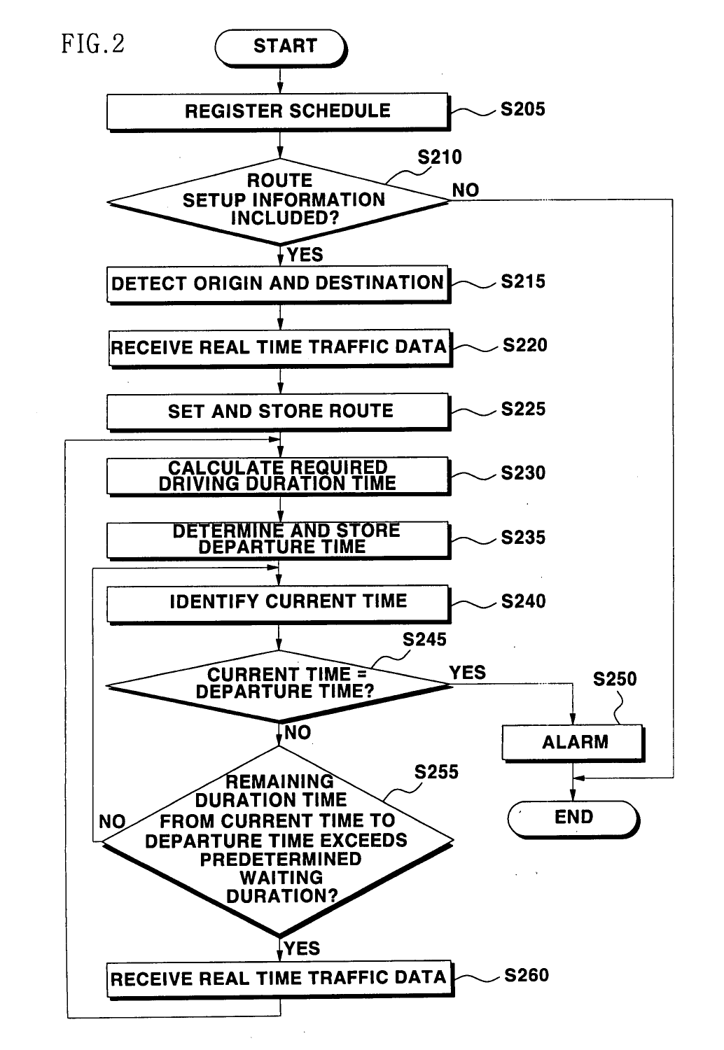

FIG. 2 is a flow chart showing a method of notifying departure time according to the present invention. Referring to FIGS. 1 and 2, a method of notifying departure time according to the present invention is described as follows. First, if a request signal for schedule registration including route setup information, such as an origin, a destination and a desired arrival time, is inputted through the key input unit 140, the control unit 150 registers and stores a schedule in the schedule management database 130 in step S205. In step S210 the control unit 150 identifies whether the route setup information is included in the schedule, and, if the route setup information is included in the schedule, executes steps S215 to S255 to notify the departure time.

In step S215, the control unit 150 detects the origin and destination included in the route setup information, and in step S220, receives real time traffic data by controlling the real time traffic data receiver 190. In step S225, the control unit 150 sets and stores a route from the origin to the destination by using the real time traffic data.

In step S230, a required driving duration time for the route is then calculated. Various technologies already disclosed in the conventional art can be used for calculating the required driving duration time for the route. For example, the control unit 150 can calculate the required driving duration time for the route by adding individual required driving duration times of links included in the route.

After calculating the required driving duration time, the control unit 150 determines and stores the departure time by using the required driving duration time and desired arrival time of the corresponding schedule in step S235. The control unit 150 preferably determines the departure time as the time preceding the desired arrival time by the required driving duration time.

Subsequently, in step S240 the control unit 150 identifies the current time, and in step S245 identifies whether the current time is equal to the departure time. In step S250, if the current time is equal to the departure time, the control unit 150 notifies the departure time (S250).

If the current time is not equal to the departure time, the control unit 150 identifies whether the remaining duration time from the current time to the departure time exceeds a predetermined waiting duration time in step S255. If the remaining duration time from the current time to the departure time exceeds the predetermined waiting duration time, the control unit 150 recalculates the required driving duration for the route by using the current traffic data, and updates the departure time by using the required driving duration time. For this, in step S260, the control unit 150 preferably receives real time traffic data by controlling the real time traffic data receiver 190, and repeats steps S230 to S260 and the following steps.

The control unit 150 updates the departure time at predetermined intervals regardless of whether the remaining duration time from the current time to the departure time exceeds the predetermined waiting duration time. Additionally, the control unit 150 preferably sets half of the required driving duration time for the route as the departure time update interval, and updates the departure time at the time preceding the departure time by the departure time update interval. The control unit 150 preferably resets the departure time update interval with a half of the previous departure update interval at predetermined intervals. Detailed examples for this have already been described describing of the functions of the control unit 150 referring to FIG. 1.

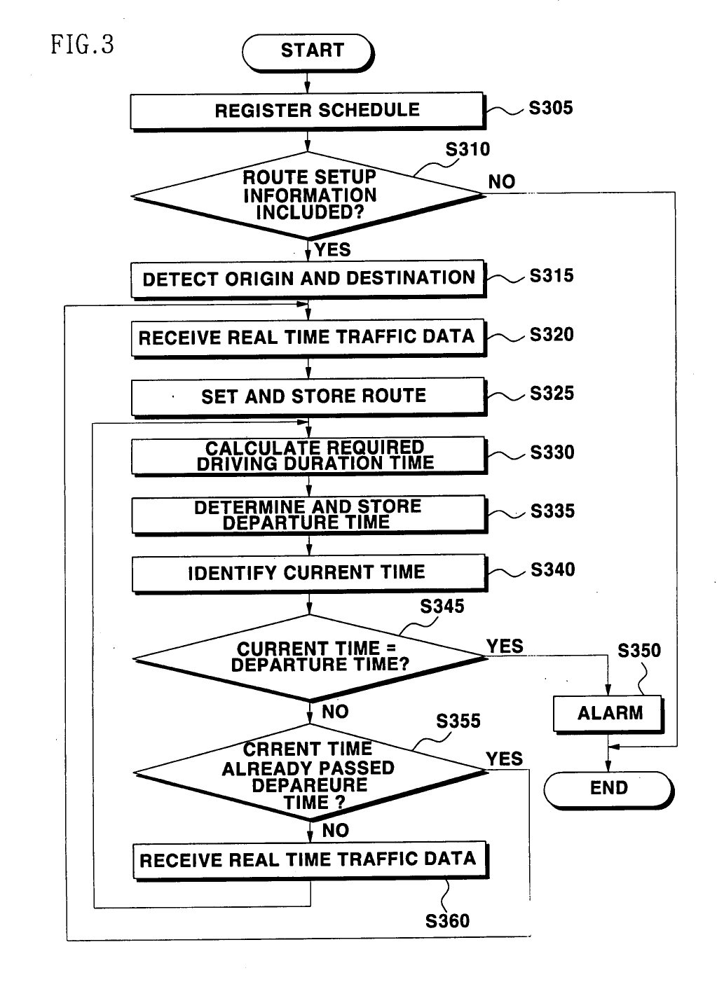

FIG. 3 is a flow chart showing a method of notifying departure time according to of the present invention. Referring to FIGS. 1 and 3, a method of notifying departure time according to the present invention is described herein as follows.

Foremost, if a request signal for schedule registration including route setup information, such as an origin, a destination and a desired arrival time, is input through the key input unit 140, the control unit 150 registers and stores a schedule in the schedule management database 130 in step S305.

In step S310 the control unit 150 identifies whether the route setup information is included in the schedule, and, if the route setup information is included in the schedule, executes steps S315 to S355 to notify the departure time. The control unit 150 detects the origin and destination included in the route setup information in step S315, and receives real time traffic data by controlling the real time traffic data receiver 190 in step S320.

In step S325, the control unit 150 sets and stores a route from the origin to the destination by using the real time traffic data. A required driving duration time for the route is then calculated in step S330. Various technologies already disclosed in the conventional art can be used for calculating of the required driving duration for the route. For example, the control unit 150 can calculate the required driving duration time for the route by adding the individual required driving duration times of links included in the route.

After calculating the required driving duration time, the control unit 150 determines and stores departure time by using the required driving duration time and desired arrival time of the corresponding schedule in step S335. The control unit 150 preferably determines the departure time as the time preceding the desired arrival time by the required driving duration time. Subsequently, in step S340, the control unit 150 identifies the current time, and in step S345 identifies whether the current time is equal to the departure time. In step S350, if the current time is equal to the departure time, the control unit 150 notifies the departure time.

If the current time is not equal to the departure time, the control unit 150 identifies whether the current time has passed the departure time in step S355. If the current time has not passed the departure time, the control unit 150 recalculates the required driving duration time for the route by using the current traffic data, and updates the departure time by using the required driving duration time. For this, the control unit 150 preferably receives real time traffic data by controlling the real time traffic data receiver 190 in step S360, and repeats steps S330 to S360.

In step S355, if the current time has passed the departure time, the control unit 150 resets the route from the origin to the destination by using real time traffic data, and accordingly updates the departure time. For this, the control unit 150 preferably repeats step S320 to S353. Detailed examples for this have already been described in the explanation of the functions of the control unit 150 referring to FIG. 1.

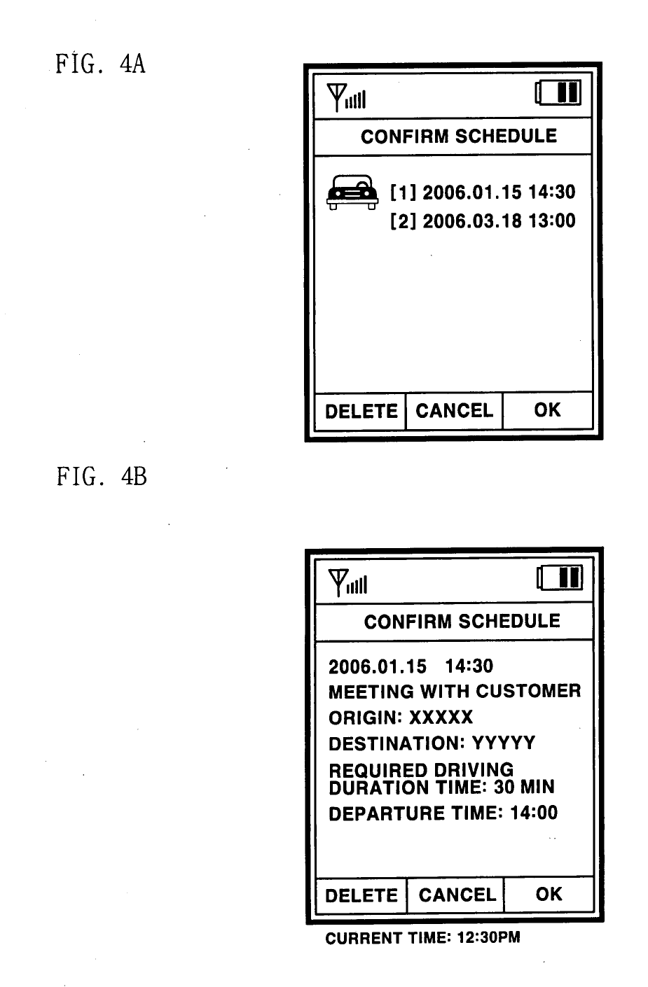

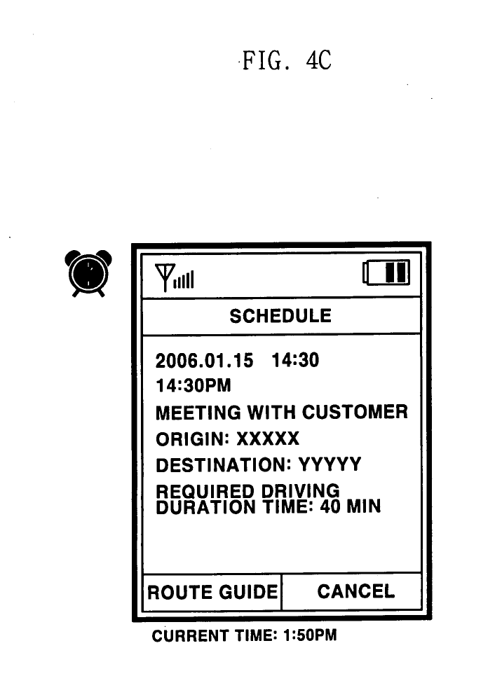

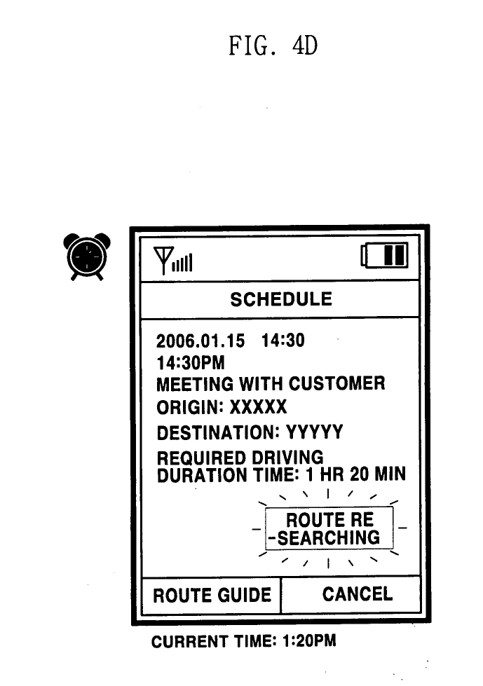

FIGS. 4A to 4D are views showing examples of schedule reference screens of an apparatus for notifying departure time according to the present invention.

FIG. 4A is an example screen showing a schedule list registered according to the present invention. In FIG. 4A, item [1] indicates a schedule including route setup information, and item [2] indicates a schedule not including route setup information. In FIG. 4A, by displaying an icon of a car shape at the left side of the schedule list including the route setup information, it can be shown that the corresponding schedule is a schedule list including route setup information. However, the present invention is not limited thereto.

FIG. 4B shows detailed contents of item [1] when a command is input to identify the detailed content of item [1] in FIG. 4A. Referring to FIG. 4B, the detailed contents of item [1] include a content of a schedule, an origin, a destination, a required driving duration time, and departure time. FIG. 4B shows an example screen where that the current time is not equal to the departure time, and the required driving duration time and departure time shown in FIG. 4B can be changed according to the traffic situation. An example of changing the required driving duration time and departure time is shown in FIGS. 2 and 3. FIG. 2 shows an example of resetting the departure time where the remaining duration time from the current time to the departure time exceeds a predetermined waiting duration time. However, the present invention is not limited to the example shown in FIG. 2. The required driving duration time and departure time can be updated at predetermined intervals regardless of whether the remaining duration time exceeds the waiting duration. Preferably, a departure time update interval is set with half of the required driving duration time for the route, the departure time is updated at the time preceding the departure time by the departure time update interval, and the departure time is updated in advance of the departure time by changing the departure time update interval in predetermined intervals. For example, the departure time update interval is set with half of the previous departure time update interval at predetermined intervals, and the departure time is updated by using the departure time update interval.

FIG. 4C shows an example screen of notifying departure time corresponding to the schedule information of item [1] in FIG. 4A, where the departure time calculated by using schedule information of item [1] is equal to the current time. That is, the apparatus for notifying departure time according to the present invention estimates that a user must depart at the current time to arrive at the destination at the scheduled time (i.e., desired arrival time), and correspondingly informs the user. Referring to FIG. 4C, the desired arrival time of the corresponding schedule is 14:30 and the required driving duration time to the destination calculated based on real time traffic data is 40 minutes. Therefore, the apparatus for notifying departure time according to the present invention informs that the user must depart at the current time (13:50) to arrive at the destination at the desired arrival time (14:30).

FIG. 4D shows an example screen where the current time has already passed the updated departure time. In FIG. 4D, the desired arrival time is 14:30, the current time is 13:20, and the required driving duration time is 1 hour 20 minutes. Accordingly, the user may be late for the meeting, because the arrival time at the destination will be 14:40, even if the user departs immediately. As such, the apparatus for notifying departure time according to the present invention informs a new route and departure time by executing ‘route re-searching’, so that the user can arrive at the destination at the desired arrival time. FIG. 4D shows that the apparatus for notifying departure time informs the user by blinking a route re-searching indicator.

Accordingly, the present invention has an advantage that a user can use scheduling functions more conveniently.

As described herein above, the present invention provides correct prediction of departure time for a route stored in a schedule by using real time traffic information including route information. Additionally, the present invention has an advantage of providing convenience to a user by notifying the departure time such that the user can arrive at a destination at the desired arrival time by using an optimum route without having to, every time, check the route and required driving duration time. Therefore, the present invention has an effect of providing more convenient scheduling functions to the user.

Although preferred embodiments of the present invention have been shown and described with reference to a certain preferred embodiment thereof, it will be understood by those skilled in the art that many variations and/or modifications of the basic inventive concept described herein, may be made therein without departing from the spirit and scope of the present invention as defined in the appended claims.

What is claimed is:

1. A method for notifying departure time, comprising:
registering a schedule including route setup information such as an origin, a destination, and a desired arrival time;
receiving real time traffic data;
setting a route from the origin to the destination;
calculating a required driving duration time for the route;
determining a departure time by using the desired arrival time and the required driving duration time;
updating the departure time by recalculating the required driving duration time for the route in advance of the departure time; and
notifying the departure time at the departure time.

2. The method of claim 1, wherein, if the remaining duration time from a current time to the departure time exceeds a predetermined waiting duration time, then the departure time is updated.

3. The method of claim 1, wherein updating the departure time is executed at predetermined intervals.

4. The method of claim 1, wherein updating the departure time comprises:
Setting a departure time update interval with half of the required driving duration time for the route, and updating at the time preceding the departure time by the departure time update interval.

5. The method of claim 4, wherein updating the departure time further comprises resetting the departure time update interval with half of the previous departure time update interval at predetermined intervals.

6. The method of claim 5, wherein, if the reset departure time update interval is shorter than a predetermined base time interval, then resetting departure time is canceled.

7. The method of claim 5, wherein, if the reset departure time update interval is shorter than the predetermined time interval, then the base interval time replaces the departure time update interval.

8. The method of claim 1, further comprising:
resetting, if the current time has already passed the updated departure time, the route from the origin to the destination; and updating the departure time by using the reset route.

9. The method of claim 1, wherein, in the step of determining the departure time, the time preceding the desired arrival time by the required driving duration time is determined as the departure time.

10. The method of claim 1, wherein notifying the departure time comprises:
displaying the determined departure time; and
identifying a predetermined notification time of the departure time and outputting an alarm signal to notify the departure time at the notification time.

11. An apparatus for departure time notification, comprising:
a schedule storage unit for storing a schedule including route setup information such as an origin, a destination, and a desired arrival time;
a real time traffic data receiver for receiving real time traffic data;
a control unit for determining, by using route setup information stored in the schedule storage unit, departure time for arrival at the destination at the desired arrival time, and in advance of the departure time, updating the departure time corresponding to the real time traffic data; and
an alarm generator for outputting an alarm signal to notify the departure time at a notification time of the departure time.

12. The apparatus of claim 11, wherein the control unit identifies the origin and the destination to determine the departure time of the schedule, sets a route from the origin to the destination, calculates a required driving duration time for the route, and determines the departure time by using the desired arrival time and the required driving duration time of the corresponding schedule.

13. The apparatus of claim 12, wherein, in advance of the departure time, the control unit updates the departure time by recalculating the required driving duration time for the route.

14. The apparatus of claim 13, wherein, if the remaining duration time from the current time to the departure time exceeds a predetermined waiting duration time, the control unit updates the departure time.

15. The apparatus of claim 13, wherein the control unit updates the departure time at predetermined intervals.

16. The apparatus of claim 13, wherein the control unit sets half of the required driving duration time for the route as a departure time update interval, and updates the departure time at the time preceding the departure time by the departure time update interval.

17. The apparatus of claim 16, wherein the control unit replaces the departure time interval with half of the previous departure time update interval at predetermined intervals.

18. The apparatus of claim 17, wherein, if the reset departure time update interval is shorter than a predetermined base time interval, the control unit cancels the resetting.

19. The apparatus of claim 17, wherein, if the reset departure time update interval is shorter than a predetermined base time interval, the control unit replaces the departure time update interval with the base time interval.

20. The apparatus of claim 11, wherein, if the current time has already passed the departure time, the control unit resets the route from the origin to the destination, and updates the departure time by using the reset route.

21. The apparatus of claim 12, wherein the control unit determines the time preceding the desired arrival time by the required driving duration time as the departure time.

22. The apparatus of claim 12, wherein the control unit controls such that the determined departure time is output at the point of determining the departure time.
